(19) United States
(12) Patent Application Publication
(10) Pub. No.: US 2017/0031668 A1
(43) Pub. Date: Feb. 2, 2017

(54) PERIPHERAL APPARATUS AND METHOD

(71) Applicant: CANON KABUSHIKI KAISHA, Tokyo (JP)

(72) Inventor: Hiroshi Kikuchi, Yokohama-shi (JP)

(21) Appl. No.: 15/209,553

(22) Filed: Jul. 13, 2016

(30) Foreign Application Priority Data
Jul. 30, 2015 (JP) 2015-150501

(51) Int. Cl. G06F 9/445; H04L 29/06; H04L 12/24; H04L 29/08

(52) U.S. Cl. CPC G06F 8/61; H04L 67/02; H04L 67/16; H04L 67/34; H04L 67/42; H04L 41/0809

(57) ABSTRACT

If the ID for a device driver having an architecture which cannot be used by an operating system currently executed on a connected personal computer (PC) is specified in a peripheral device, a suitable device driver cannot be installed in the connected PC on a Plug and Play basis. Therefore, in Plug and Play, based on information of the operating system, the peripheral device performs control to transmit the ID of a device driver having a suitable architecture to the connected PC.

### BACKGROUND OF THE INVENTION

Field of the Invention

The present invention relates to a technique for installing a device driver when connecting an information processing apparatus such as a personal computer and a peripheral device such as a printer.

Description of the Related Art

There have conventionally been peripheral devices for which a plurality of types of device drivers is prepared. For example, certain printers support various types of Page Description Languages (PDLs). These printers manage identification information (for example, a Plug and Play identifier (ID)) for all types of PDLs. With a technique called Plug and Play (PnP), if an information processing apparatus acquires identification information for any one type of PDL from a printer, the information processing apparatus is able to install a printer driver for the PDL corresponding to the identification information.

However, a user who uses a printer driver only for one type of PDL does not need a printer driver for a plurality of PDLs. A certain technique such as one discussed in Japanese Patent Application Laid-Open No. 2007-097156 is known to enable a user to select which PDL's Plug and Play is to be generated.

In recent years, for the Windows (registered trademark) operating system (OS), what are called the v3 and v4 printer drivers has been released. Although these printer drivers operate on the same OS, they have completely different architectures and accordingly provide different screens (graphical user interfaces (GUIs)), different functions, and different operating procedures. For example, unlike conventional printer drivers, the v4 printer driver offers GUIs specialized for touch panel display.

It is assumed that in the future the latest OS will stop supporting printer drivers having earlier architectures. In such a case, a plurality of information processing apparatuses existing in a network environment may include apparatuses with the latest OS installed thereon and apparatuses without it.

If an ID corresponding to a printer driver having an earlier architecture is set to a printer based on a method of a prior art, a problem will arise. More specifically, on the latest OS, it becomes impossible to install the printer driver on a Plug and Play basis. To solve this problem, each time a new printer is connected to an information processing apparatus, a user may determine the OS of the information processing apparatus and accordingly change identification information (to be used for Plug and Play) set in the printer. However, this method is time-consuming.

### SUMMARY OF THE INVENTION

According to an aspect of the present invention, a peripheral device includes, a specification unit configured to specify a device driver to be installed in an information processing apparatus connected to the peripheral device from a list of device drivers including device drivers having a first architecture and device drivers having a second architecture, an acquisition unit configured to acquire information of an operating system operating on the connected information processing apparatus, a determination unit configured to, based on the information of the operating system, determine whether the operating system supports only device drivers having the second architecture, and a transmission unit configured to, in a case where a device driver having the first architecture is specified by the specification unit and where the operating system is determined to support only device drivers having the second architecture by the determination unit, transmit, to the information processing apparatus, identification information corresponding to a device driver having the second architecture which can handle a command type handled by the device driver having the first architecture specified by the specification unit or identification information corresponding to a device driver having the second architecture which can handle a command type preset in the peripheral device. In a case where the device driver having the second architecture is specified by the specification unit and where the operating system is determined to support only device drivers having the second architecture by the determination unit, the transmission unit transmits, to the information processing apparatus, identification information corresponding to the device driver having the second architecture specified by the specification unit.

Further features of the present invention will become apparent from the following description of exemplary embodiments with reference to the attached drawings.

### BRIEF DESCRIPTION OF THE DRAWINGS

FIGS. 1A and 1B illustrate forms of connection between a computer and a printer.

FIGS. 2A and 2B illustrate configurations of the computer and the printer.

FIG. 3 illustrates a transition of user interfaces provided by the printer.

FIG. 4 is a flowchart illustrating processing in network (Web Services on Devices (WSD)) connection according to a first exemplary embodiment.

FIG. 5 is a flowchart illustrating details of processing for transmitting to the computer an identifier (ID) corresponding to a device driver having a second architecture.

FIG. 6 illustrates examples of Plug and Play (PnP) IDs transmitted to the computer according to the present exemplary embodiment.

FIG. 7 illustrates an example of GetPrinterElements.

FIG. 8 illustrates an example of a response to GetPrinterElements.

FIG. 9 is a flowchart illustrating processing in Universal Serial Bus (USB) connection according to a second exemplary embodiment.

### DESCRIPTION OF THE EMBODIMENTS

Exemplary embodiments of the present invention will be described below with reference to the accompanying drawings.

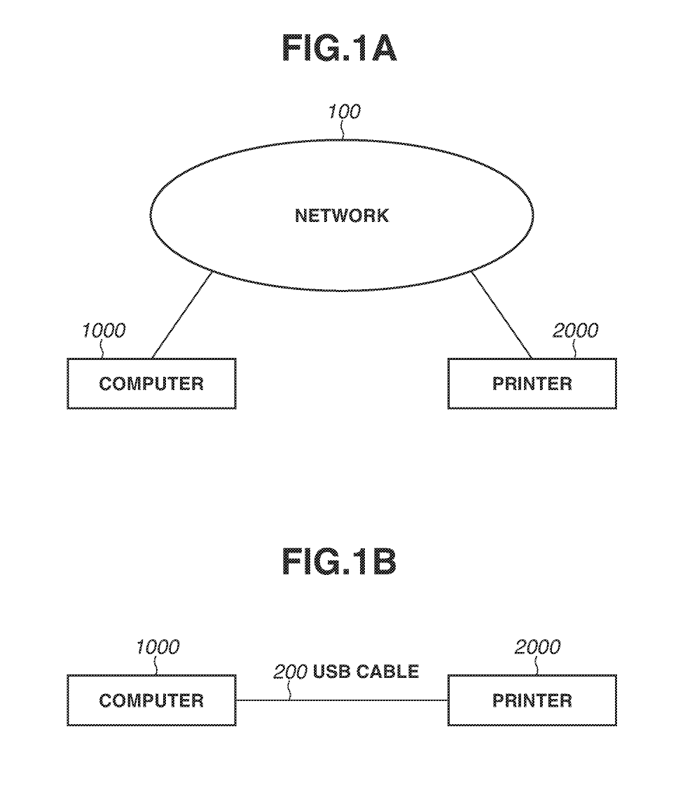

FIG. 1A illustrates a form of connection between a computer 1000 and a printer 2000 according to a first exemplary embodiment. The computer 1000 and the printer 2000 as a peripheral device thereof are connected to a network 100. The present invention relates to a technique of installing a device driver. The first exemplary embodiment will be described below centering on Network Plug and Play related to printer drivers by Web Services on Devices (WSD) Discovery. Therefore, the printer 2000 will be described below on the premise that the WSD function is enabled. In addition to WSD, Simple Service Discovery Protocol (SSDP) and other network protocols enabling installation of device drivers, as with Network Plug and Play, are also applicable to the present invention.

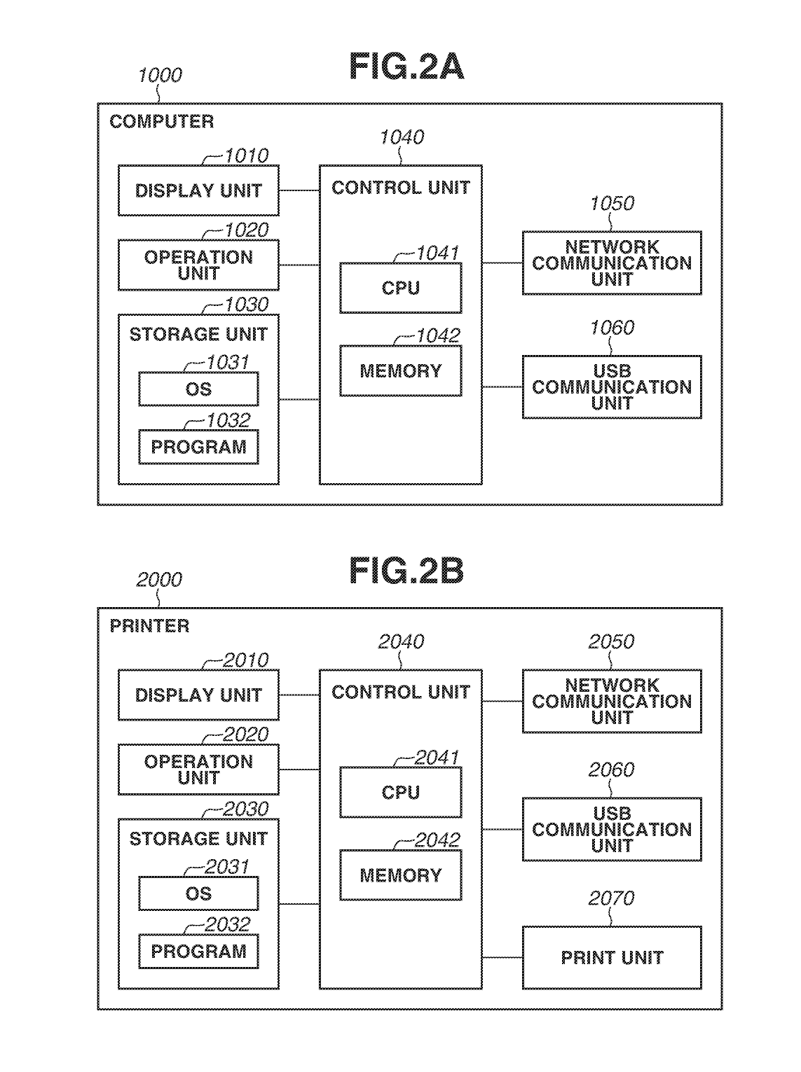

FIGS. 2A and 2B are block diagrams illustrating configurations of the computer 1000 and the printer 2000.

The configuration of the computer 1000 serving as an information processing apparatus will be described below. The computer 1000 is totally controlled by a control unit 1040 which includes a central processing unit (CPU) 1041 and a memory 1042. A display unit 1010 indicates an output apparatus such as a display. An operation unit 1020 includes input apparatuses such as a mouse and a keyboard. Software such as an OS 1031 and various programs 1032 is stored in a storage unit 1030. When necessary, the CPU 1041 loads any one of these programs into the memory 1042 and then executes it. The OS 1031 is software for managing basic operations of the computer 1000. A network communication unit 1050 connects to the network 100 and outputs and inputs data with an external apparatus. A Universal Serial Bus (USB) communication unit 1060 inputs and outputs data from/to an external apparatus connected via a USB cable. According to the present invention, the CPU 1041 in the control unit 1040 loads software stored in the storage unit 1030 into the memory 1042 and, thereby, all pieces of processing of the computer 1000 are implemented.

The present invention assumes three different types of OS's. Under one type of OS's, printer drivers having completely different architectures, such as the v3 and v4 printer drivers, operate. Under another type of OS's, only the v3 printer driver operates. Under still another type of OS's, only the v4 printer driver operates. All of the three different types of OS's may be installed as the OS 1031 of the computer 1000.

The configuration of the printer 2000 will be described below. The printer 2000 is totally controlled by a control unit 2040 which includes a CPU 2041 and a memory 2042. A display unit 2010 indicates an output apparatus such as a panel. An operation unit 2020 includes input apparatuses such as a touch panel and various buttons. An OS 2031 and various programs 2032 are stored in a storage unit 2030. These programs are loaded into the memory 2042 and then executed by the CPU 2041 as required. The OS 2031 is software for managing basic operations of the printer 2000. A network communication unit 2050 connects to the network 100 and inputs and outputs data from/to an external apparatus. A USB communication unit 1060 inputs and outputs data from/to an external apparatus connected via a USB cable. A print unit 2070 prints by fixing a toner and ink to paper according to directions of the control unit 2040, and by forming the target image on the physical paper. According to the present invention, the CPU 2041 in the control unit 2040 loads software stored in the storage unit 2030 into the memory 2042 and thereby, all pieces of processing of the printer 2000 are implemented.

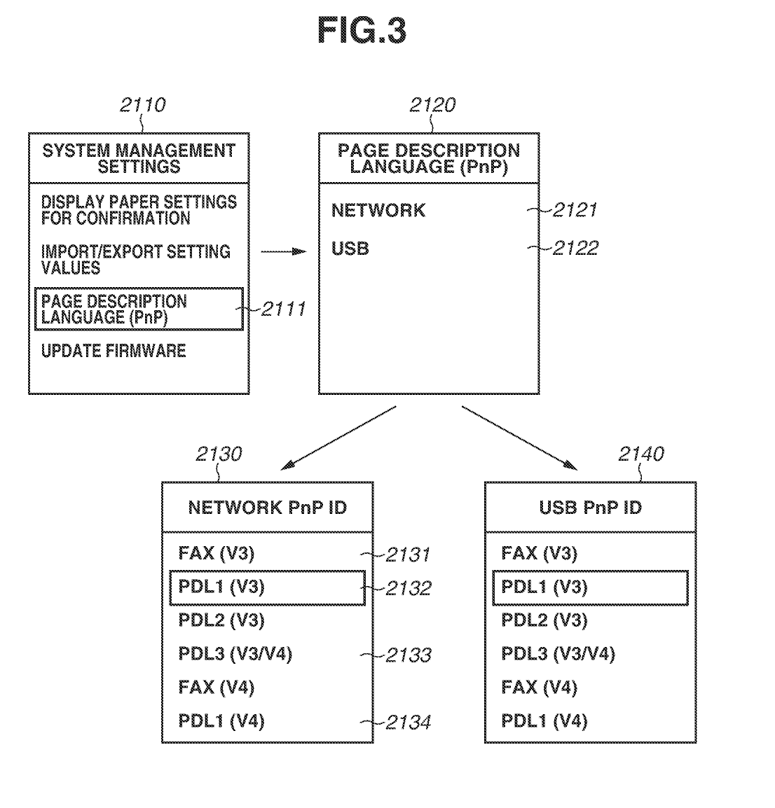

FIG. 3 illustrates a transition of user interfaces (UIs) provided by the printer 2000 to enable the user to select identification information of a device driver. In this case, PnP IDs corresponding to PDLs for printer drivers are displayed as examples of identification information. Therefore, identification information selected in these UIs is used to install a device driver in an information processing apparatus.

The UIs are displayed on the display unit 2010 of the printer 2000. Upon reception of a user input on the operation unit 1020, such as a touch panel operation or a button operation, a UI transition occurs.

A “System Management Settings” screen 2110 is a UI for setting various system management functions of the printer 2000. PnP IDs according to the present exemplary embodiment can be selected and set when a “Page Description Language (PnP)” option 2111 is selected. When the “Page Description Language (PnP)” option 2111 is selected, a “Page Description Language (PnP)” screen 2120 is displayed. In this case, a PnP ID can be specified for each form of connection (a “Network” option 2121 and a “USB” option 2122).

When the “Network” option 2121 is selected, a “Network PnP ID” screen 2130 is displayed. This screen displays a list of all device drivers corresponding to IDs which can be used as PnP IDs by the printer 2000. The system administrator of the printer 2000 specifies a printer driver for a PDL to be subjected to Network Plug and Play from the list on this screen.

“(V3)” at the end of the ID in the list indicates that the printer driver has the architecture used in the conventional OS. On the other hand, “(V4)” indicates that the printer driver has the architecture used in the new OS. For example, the v4 printer driver has a feature of providing GUIs specialized for touch panel display unlike printer drivers having the conventional architectures. “PDL1”, “PDL2”, etc. indicate different types of PDLs.

The printer 2000 has a “PDL1 (V3)” default setting 2132. A “FAX (V3)” option 2131 is used to install a FAX driver having the V3 architecture on the computer 1000 on a Plug and Play basis. For example, when the system administrator selects the “FAX (V3)” option 2131, the Network PnP ID setting of the printer 2000 is changed to “FAX (V3)” and the “Page Description Language (PnP)” screen is redisplayed.

A “PDL3 (V3/V4)” option 2133 corresponds to a special PnP ID. More specifically, there is a case where both a printer driver for “PDL3” having the V3 architecture and a printer driver for “PDL3” having the V4 architecture are associated with the same PnP ID. Therefore, when this special PnP ID is selected and the printer 2000 connects with the computer 1000 on which the OS applicable to both architectures operates, a printer driver having a high priority for the OS 1031 will be selectively installed and used.

A “PDL1 (V4)” option 2134 is used to install a printer driver for “PDL1” having the V4 architecture on a Plug and Play basis.

There is no option of the printer driver for “PDL2” having the V4 architecture, for example, because the printer driver is not supported by the printer vendor. In the present exemplary embodiment, the printer vendor sets “PDL1” as the most recommended PDL (referred to as a recommended PDL) out of a plurality of PDLs.

When the “USB” option 2122 is selected on the screen 2120, a “USB PnP ID” screen 2140 is displayed. The contents of this screen are similar to those of the “Network PnP IS” screen 2130 and redundant descriptions thereof will be omitted.

As described above, in the present exemplary embodiment, the system administrator of the printer 2000 can specify different PnP IDs between network connection and USB connection.

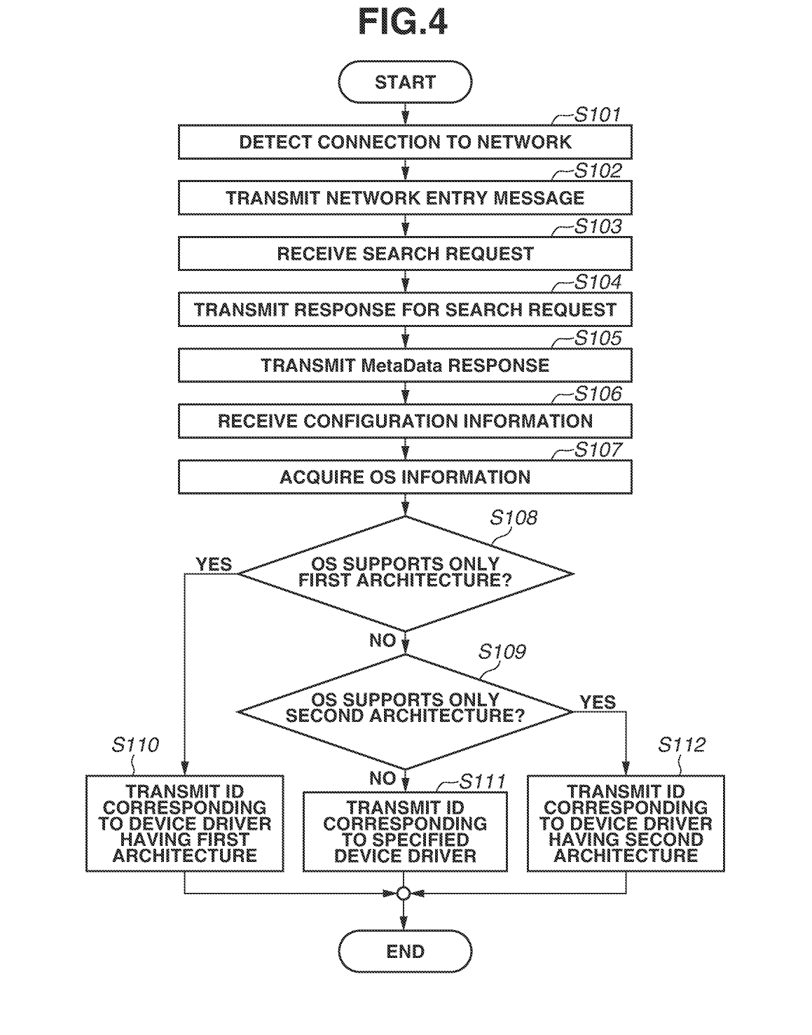

FIG. 4 is a flowchart illustrating processing of the printer 2000 when the printer 1000 is connected to the network 100 in a state where the PnP ID illustrated in FIG. 3 is set. The CPU 2041 in the control unit 2040 loads software stored in the storage unit 2030 into the memory 2042, and thereby, this processing is implemented when.

In step S101, the printer 2000 detects that it has been connected to the network 100. In step S102, the printer 2000 transmits a network entry message, by multicast, to the network 100. For example, the network entry message indicates the “Hello” message in WSD Discovery.

In step S103, the printer 2000 receives a search request from the computer 1000 connected to the network 100. For example, the search request indicates a “Probe” message in WSD Discovery. In step S104, in response to the search request, the printer 2000 transmits a response to the computer 1000. For example, this response indicates the “ProbeMatch” message in WSD Discovery. In step S105, the printer 2000 transmits a MetaData response to the computer 1000.

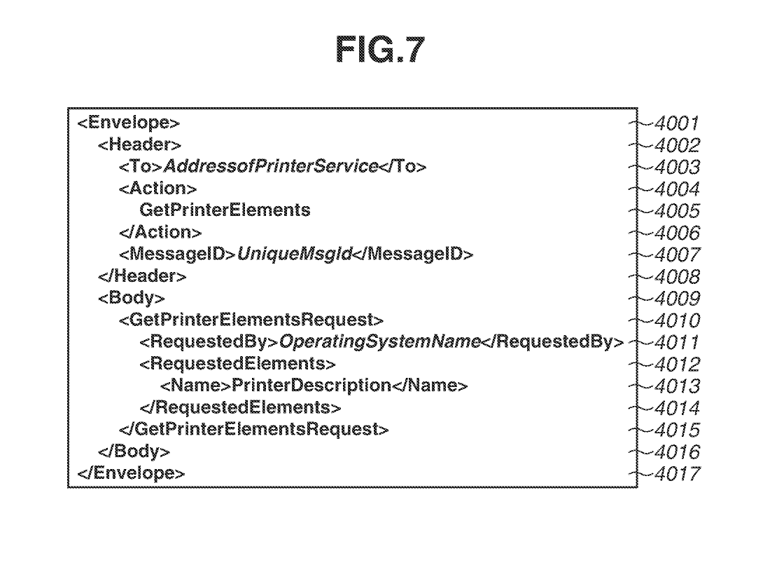

In step S106, the printer 2000 receives configuration information from the computer 1000. For example, the configuration information indicates the “GetPrinterElements” message in WSD Discovery. An example will be described below with reference to FIG. 7.

In step S107, the printer 2000 confirms OS information of the computer 1000. As a method for confirming the OS information of the computer 1000, for example, the printer 2000 may acquire OS information included in the Extensible Markup Language (XML) data in the configuration information. Further, the XML data may be analyzed to determine necessary OS information. Other methods may be used to acquire necessary OS information. For example, the OS information may be acquired from other information resources connected to the network 100.

In step S108, based on the OS information acquired in step S107, the printer 2000 determines whether the OS of the computer 1000 supports only device drivers having a first architecture. The first architecture means, for example, the above-described V3 architecture. When the OS supports only the first architecture (YES in step S108), the processing proceeds to step S110. On the other hand, when the OS does not support the first architecture (NO in step S108), the processing proceeds to step S109.

In step S110, following the specification on the screen 2130 illustrated in FIG. 3, the printer 2000 transmits the ID corresponding to a device driver having the first architecture to the computer 1000. More specifically, when the “PDL1 (V3)” option 2132 is specified on the screen 2130 illustrated in FIG. 3, the printer 2000 transmits the PnP ID corresponding to the printer driver for “PDL1” having the V3 architecture to the computer 1000 following the specification. When the “PDL2 (V3)” or the “PDL3 (V3/V4)” option is specified on the screen 2130 illustrated in FIG. 3, the printer 2000 transmits the PnP ID corresponding to each PDL to the computer 1000 following these specifications.

In step S109, based on the OS information acquired in step S107, the printer 2000 determines whether the OS of the computer 1000 supports only device drivers having a second architecture. The second architecture means, for example, an architecture completely different from the first architecture, such as the above-described V4 architecture. When the OS supports only the second architecture (YES in step S109), the processing proceeds to step S112. On the other hand, when the OS supports not only the second architecture (NO in step S109), the processing proceeds to step S111.

In step S111, the OS of the computer 1000 supports both the first and the second architectures, the printer 2000 transmits the PnP ID following the specification on the screen 2130 illustrated in FIG. 3 to the computer 1000.

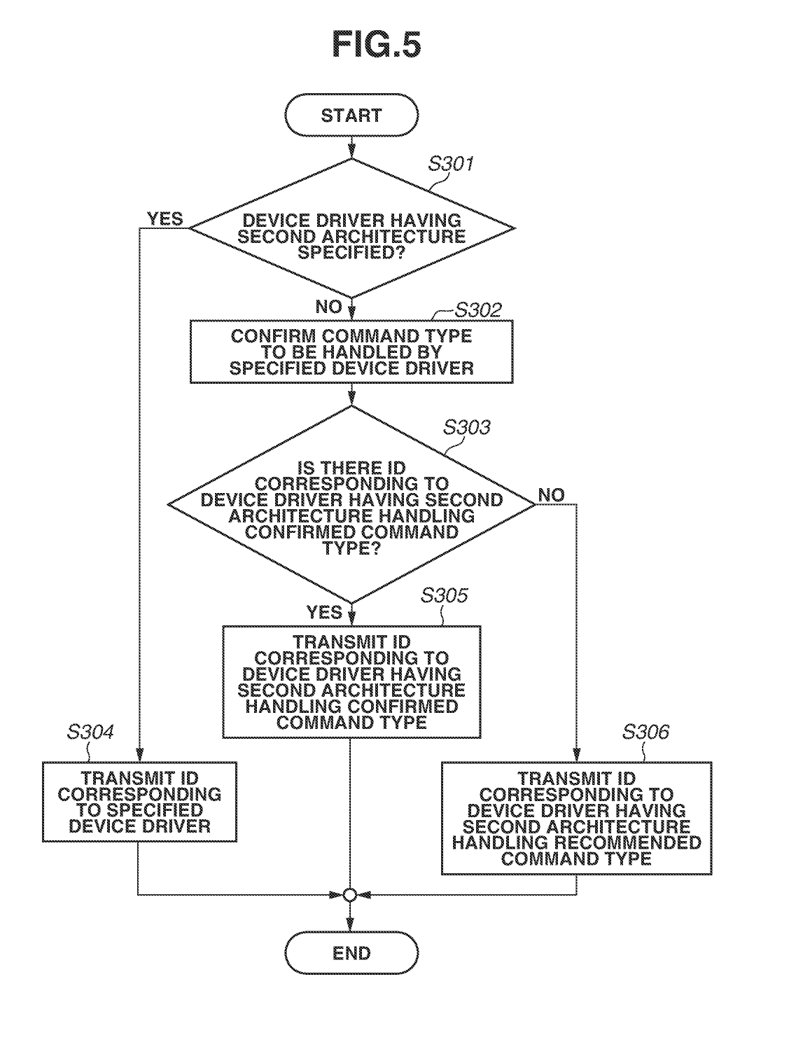

In step S112, following the specification on the screen 2130 illustrated in FIG. 3, the printer 2000 transmits the ID corresponding to a device driver having the second architecture to the computer 1000. For example, even when a PDL related to the V3 architecture as with the “PDL1 (V3)” option 2132 is specified, the printer 2000 transmits a PnP ID having the V4 architecture to the computer 1000 with reference to this specification. A determination method used when transmitting to the computer 1000 an ID different from that regarding the specification on the screen 2130 illustrated in FIG. 3 in step S112 will be described in detail below with reference to FIG. 5. When the “PDL3 (V3/V4)” option 2133, a “FAX (V4)” option, or the “PDL1 (V4)” option 2134 is specified on the screen 2130 illustrated in FIG. 3, the printer 2000 transmits the PnP ID corresponding to each PDL to the computer 1000, as it is, following the specification.

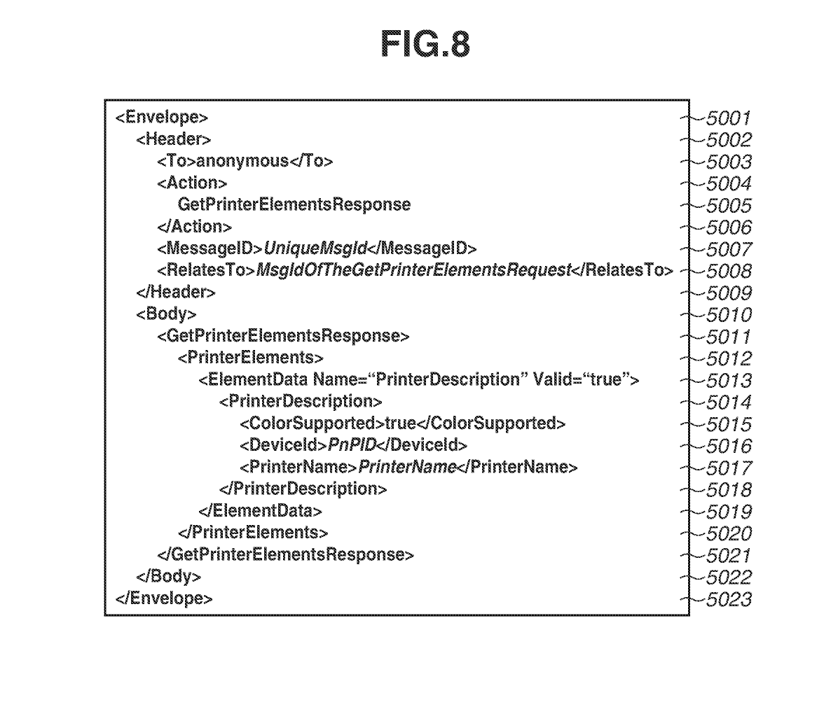

An example of a response to the configuration information (for example, “GetPrinterElements”) received from the computer 1000 in step S106 will be described below with reference to FIG. 8. This response is transmitted from the printer 2000 to the computer 1000 in step S110, S111, or S112.

FIG. 5 is a flowchart illustrating details of the processing in step S112 illustrated in FIG. 4.

In step S301, the printer 2000 determines whether the device driver specified on the screen 2130 illustrated in FIG. 3 corresponds to a device driver having the second architecture. When a device driver having the second architecture is specified (YES in step S301), then in step S304, the printer 2000 transmits the ID corresponding to the device driver specified on the screen 2130 to the computer 1000. For example, when the “PDL3 (V3/V4)” option 2133 or the “PDL1 (V4)” option 2134 is specified on the screen 2130, then in step S304, the PnP ID corresponding to the specification is transmitted to the computer 1000 as it is.

When a device driver having the second architecture is not specified (NO in step S301), then in step S302, the printer 2000 confirms the command type (PDL information) to be handled by the device driver specified on the screen 2130. In step S303, the printer 2000 determines whether there is an ID corresponding to a device driver having the second architecture handling the command type confirmed in step S302. For example, when the “PDL1 (V3)” option 2132 is specified, there is a PDL (the “PDL1 (V4)” option 2134) indicating a printer driver having the V4 configuration handling “PDL1” (YES in step S303). When there is an ID corresponding to a device driver having the second architecture handling the command type confirmed in step S302 (YES in step S303), then in step S305, the printer 2000 transmits the ID corresponding to a device driver having the second architecture handling the command type confirmed in step S302 to the computer 1000. For example, when the device driver having the second architecture handling the command type confirmed in step S302 is the “PDL1 (V4)” 2134, the PnP ID corresponding to the “PDL1 (V4)” option 2134 is transmitted to the computer 1000.

On the other hand, when there is no ID corresponding to a device driver having the second architecture handling the command type confirmed in step S302 (NO in step S303), for example, when the “PDL2 (V3)” option is specified on the screen 2130, the processing proceeds to step S306. In step S306, the printer 2000 transmits to the computer 1000 the ID corresponding to a device driver having the second architecture handling the recommended command type. With the printer 2000 according to the present exemplary embodiment, the recommended PDL is “PDL1” as described above. Therefore, for example, the printer 2000 transmits the PnP ID corresponding to the “PDL1 (V4)” option 2134 to the computer 1000.

In step S110, the printer 2000 is able to determine the ID corresponding to a device driver having the first architecture to be transmitted to the computer 1000, based on a method equivalent to that illustrated in FIG. 5. Specifically, when a device driver having the second architecture is specified on the screen 2130, the printer 2000 determines the ID to be transmitted to the computer 1000, based on the command type of the specified device driver and the recommended command type.

According to the descriptions of the present exemplary embodiment, the printer 2000 does not return the ID for a device driver having an unsupported architecture depending on information of the OS 1031 operating on the connection target computer 1000. Further, even in a case where device drivers having a new architecture are not prepared, device drivers of the command type (PDL) recommended by the device vendor can be used for Plug and Play.

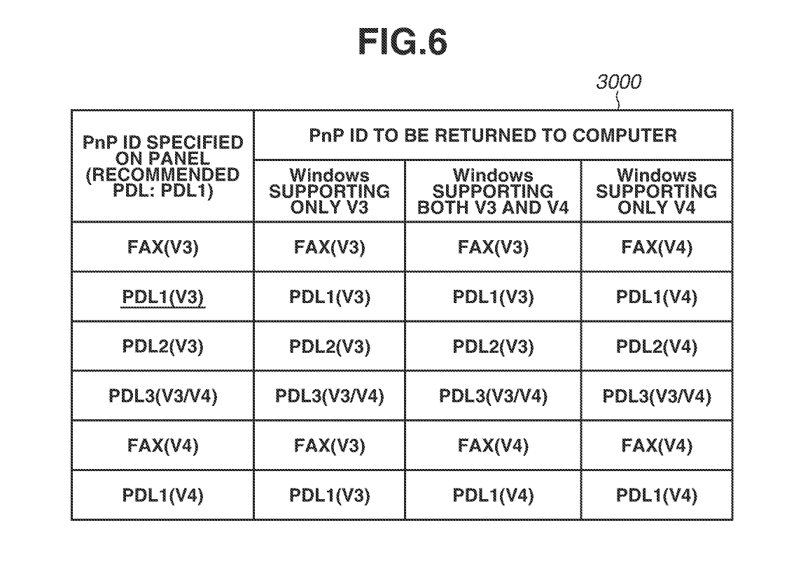

FIG. 6 is a table illustrating relations between printer drivers specified on the touch panel and PnP IDs to be actually returned from the printer 2000 to the computer 1000 when the processing illustrated in FIGS. 4 and 5 is applied.

Referring to FIG. 6, Windows (registered trademark) supporting only the V3 architecture is described as an example of an OS supporting only device drivers having the first architecture. Likewise, Windows (registered trademark) supporting only the V4 architecture is described as an example of an OS supporting only device drivers having the second architecture. Further, “PDL1” is described as an example of a recommended command type set in the printer 2000.

FIG. 7 illustrates an example of “GetPrinterElements” as configuration information received by the printer 2000 in step S106.

“GetPrinterElements” is a Simple Object Access Protocol (SOAP) message having the XML format defined by WSD, and is entirely enclosed in “Envelope” (4001 to 4017). “Envelope” (4001 to 4017) includes “Header” (4002 to 4008) and “Body” (4009 to 4016).

“Header” (4002 to 4008) includes “To” (4003), “Action” (4004 to 4006), and “MessageID” (4007). “To” (4003) describes the address of the printer 2000 as the destination of this SOAP message. “Action” (4004 to 4006) describes that this SOAP message is “GetPrinterElements” (4005). “MessageID” (4007) describes a UUID (Universally Unique Identifier) indicating this SOAP message.

“Body” (4009 to 4016) includes “GetPrinterElementsRequest” (4010 to 4015) which is the request of this SOAP message. “GetPrinterElementsRequest” (4010 to 4015) includes “RequestedBy” (4011) and “RequestedElements” (4012 to 4014). “RequestedBy” (4011) describes the type of the OS which is the transmission source of this SOAP message. In step S107, the printer 2000 refers to “RequestedBy” (4011) to confirm the information of the requesting OS. “RequestedElements” (4012 to 4014) describes the name of information requested by this SOAP message. In this example, “RequestedElements” (4012 to 4014) describes “PrinterDescription” (4013).

FIG. 8 illustrates an example of a response to “GetPrinterElements” transmitted from the printer 2000 to the computer 1000 in step S110, S111, or S112.

A response to “GetPrinterElements” is a SOAP message having the XML format defined by WSD and is entirely enclosed in “Envelope” (5001 to 5023). “Envelope” (5001 to 5023) includes “Header” (5002 to 5009) and “Body” (5010 to 5022).

“Header” (5002 to 5009) includes “To” (5003), “Action” (5004 to 5006), “MessageID” (5007), and “RelatesTo” (5008). “To” (5003) describes the address of the computer 1000 as the destination of this SOAP message. In the present exemplary embodiment, “To” (5003) describes “anonymous.” “Action” (5004 to 5006) describes that this SOAP message is “GetPrinterElementsResponse” (5005). “MessageID” (5007) describes a UUID (Universally Unique Identifier) indicating this SOAP message. “RelatesTo” (5008) describes which SOAP message the response is to. In the present exemplary embodiment, since this message is a response to “GetPrinterElements” illustrated in FIG. 7, “MessageID” (5007) describes the same UUID as that in “MessageID” (4007).

“Body” (5010 to 5022) includes “GetPrinterElementsResponse” (5011 to 5021) which is a request of this SOAP message. “GetPrinterElementsResponse” (5011 to 5021) includes “PrinterElements” (5012 to 5020). “PrinterElements” (5012 to 5020) includes “ElementData” (5013 to 5019). “ElementData” (5013 to 5019) includes “PrinterDescription” (5014 to 5018) requested by the computer 1000. “PrinterDescription” (5014 to 5018) includes “ColorSupported” (5015), “DeviceId” (5016), and “PrinterName” (5017). “ColorSupported” (5015) indicates whether the printer 2000 is a color printer or a monochrome printer. In the present exemplary embodiment, “ColorSupported” (5015) describes “true” since it is a color machine. “DeviceId” (5016) describes the Plug and Play ID of the printer 2000. The transmission of the ID in step S110, S111, or S112 illustrated in FIG. 4 or described in FIG. 5 is implemented when the ID is stored as the value of “DeviceId” (5016). “PrinterName” (5017) describes the name of the printer 2000.

Although the first exemplary embodiment has been described above centering on Network Plug and Play such as WSD Discovery, a second exemplary embodiment will be described below centering on Plug and Play by USB connection.

FIG. 1B illustrates a form of connection between the computer 1000 and the printer 2000 according to the second exemplary embodiment. The computer 1000 and the printer 2000 are connected via a USB cable 200. The configurations illustrated in FIG. 2 and the UI transition illustrated in FIG. 3 according to the second exemplary embodiment are similar to those according to the first exemplary embodiment, and redundant descriptions thereof will be omitted.

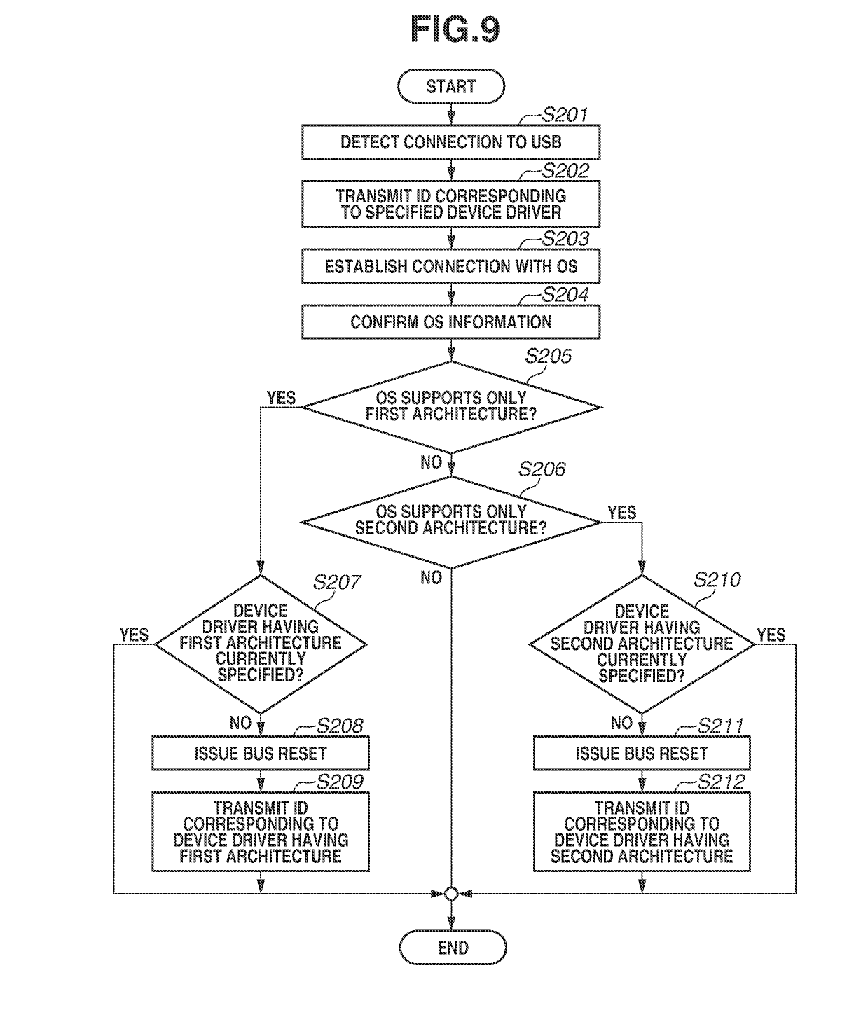

FIG. 9 is a flowchart illustrating processing of the printer 2000 when the computer 1000 is connected to the printer 2000 with the USB cable 200 after any one device driver is specified on the screen 2140 illustrated in FIG. 3. As with the first exemplary embodiment, the CPU 2041 in the control unit 2040 loads software stored in the storage unit 2030 into the memory 2042, and thereby, this processing is implemented.

In step S201, the printer 2000 detects that it has been connected to the computer 1000 via the USB cable 200. In step S202, the printer 2000 transmits to the computer 1000 the ID corresponding to the device driver specified on the screen 2140. In step S203, by using the transmitted ID, the printer 2000 establishes a USB connection with the OS 1031 of the computer 1000.

In step S204, the printer 2000 confirms the information of the OS 1031 of the connected computer 1000. As a method for confirming the information of the OS 1031, for example, the printer 2000 can acquire the information by communicating with a device driver preinstalled in the computer 1000. The OS information can be acquired with various methods, for example, by determining the information based on the behavior of the OS 1031 after USB connection or by acquiring the information from other information resources separately stored. Any method can be used to acquire the OS information.

In step S205, based on the OS information confirmed in step S204, the printer 2000 determines whether the OS 1031 operating on the computer 1000 supports only the first architecture. When the OS supports only the first architecture (YES in step S205), the processing proceeds to step S207. On the other hand, when the OS supports not only the first architecture (NO in step S205), the processing proceeds to step S206.

In step S207, the printer 2000 determines whether a device driver having the first architecture is currently specified on the screen 2140 illustrated in FIG. 3. In this case, when a device driver having the first architecture (for example, “PDL1 (V3)”) is specified on the screen 2140 (YES in step S207), the processing exits this flowchart. On the other hand, when a device driver having the second architecture (for example, “PDL1 (V4)”) is specified on the screen 2140 (NO in step S207), then in step S208, the printer 2000 issues a USB bus reset. As a method for performing bus reset, for example, the printer 2000 temporarily stops the D+ signal line of a USB cable which is normally pulled up. In step S209, the printer 2000 determines the ID corresponding to a device driver having the first architecture and transmits the determined ID to the computer 1000. When the printer 2000 retransmits the ID in step S209, Plug and Play for a device driver having the first architecture will be performed by the computer 1000. The method for determining the ID corresponding to a device driver having the first architecture in step S209 can be performed in a similar way to the method described above with reference to FIG. 5. Specifically, when a device driver having the second architecture is specified on the screen 2140, the printer 2000 will determines the ID to be transmitted to the computer 1000 based on the command type of the specified device driver and the recommended command type.

In step S206, based on the OS information confirmed in step S204, the printer 2000 determines whether the OS 1031 operating on the computer 1000 supports only the second architecture. When the OS supports only the second architecture (YES in step S206), the processing proceeds to step S210. On the other hand, when the OS supports not only the second architecture (NO in step S206), the processing exits this flowchart.

In step S210, the printer 2000 determines whether a device driver having the second architecture is currently specified on the screen 2140 illustrated in FIG. 3. When a device driver having the second architecture (for example, “PDL1 (V4)”) is currently specified on the screen 2140 (YES in step S210), the processing exits this flowchart. On the other hand, when a device driver having the first architecture (for example, “PDL1 (V3)”) is specified on the screen 2140 (NO in step S210), then in step S211, the printer 2000 issues a USB bus reset. In step S212, the printer 2000 determines the ID corresponding to a device driver having the second architecture and transmits the determined ID to the computer 1000. When the printer 2000 retransmits the ID in step S209, Plug and Play for a device driver having the second architecture will be performed by the computer 1000. The method for determining the ID corresponding to a device driver having the second architecture in step S209 can be performed in a similar way to the method described above with reference to FIG. 5.

In the above-described example, in step S202 illustrated in FIG. 9, the printer 2000 transmits the ID corresponding to a device driver specified on the screen 2140 to the computer 1000. However, the printer 2000 may transmit another dummy ID. In this case, the printer 2000 acquires the OS information of the computer 1000 by using the device driver for the dummy ID. In this case, after the printer 2000 acquires the OS information, it necessarily issues a bus reset and transmits the ID corresponding to a device driver specified on the screen 2140 or the ID determined in step S209 or S212 to the computer 1000.

According to the present exemplary embodiment, it is possible to transmit to the computer 1000 the ID corresponding to a device driver applicable to the OS information of the connected computer 1000 even at the time of USB connection. Therefore, the printer 2000 does not return the ID corresponding to a device driver having an architecture that is not supported by the OS of the computer 1000 connected via the USB cable.

Exemplary embodiments (the first and the second exemplary embodiments) and effects of the present invention have been described above with reference to the accompanying drawings. Although, in the present invention, Windows (registered trademark) is used as the OS 1031 of the computer 1000, other OS's are similarly applicable. Although a printer is used as an example of a peripheral device, the present invention is also applicable to other apparatuses having a similar background, such as a scanner and the like.

The present invention includes an apparatus or a system configured by suitably combining the above-described exemplary embodiments, and also includes a method in the apparatus or the system.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-150501, filed Jul. 30, 2015, which is hereby incorporated by reference herein in its entirety.

What is claimed is:

1. A peripheral device comprising:
a specification unit configured to specify a device driver to be installed in an information processing apparatus connected to the peripheral device from a list of device drivers including device drivers having a first architecture and device drivers having a second architecture;
an acquisition unit configured to acquire information of an operating system operating on the connected information processing apparatus;
a determination unit configured to, based on the information of the operating system, determine whether the operating system supports only device drivers having the second architecture; and
a transmission unit configured to, in a case where a device driver having the first architecture is specified by the specification unit and where the operating system is determined to support only device drivers having the second architecture by the determination unit, transmit, to the information processing apparatus, identification information corresponding to a device driver having the second architecture which can handle a command type handled by the device driver having the first architecture specified by the specification unit or identification information corresponding to a device driver having the second architecture which can handle a command type preset in the peripheral device,
wherein, in a case where the device driver having the second architecture is specified by the specification unit and where the operating system is determined to support only device drivers having the second architecture by the determination unit, the transmission unit transmits, to the information processing apparatus, identification information corresponding to the device driver having the second architecture specified by the specification unit.

2. The peripheral device according to claim 1, wherein, in a case where the information processing apparatus is connected to the peripheral device via a USB cable, the acquisition unit acquires the information of the operating system operating on the information processing apparatus after identification information corresponding to the device driver specified by the specification unit or dummy identification information is transmitted to the information processing apparatus, and
wherein, in a case where a device driver having the first architecture is specified by the specification unit and where the operating system is determined to support only device drivers having the second architecture by the determination unit, the transmission unit, after a bus reset is issued, transmits, to the information processing apparatus, identification information corresponding to a device driver having the second architecture which can handle a command type handled by the device driver having the first architecture specified by the specification unit or identification information corresponding to a device driver having the second architecture which can handle a command type preset in the peripheral device.

3. The peripheral device according to claim 1, wherein, based on the information of the operating system, the determination unit further determines whether the operating system supports only device drivers having the first architecture,
wherein, in a case where a device driver having the second architecture is specified by the specification unit and where the operating system is determined to support only device drivers having the first architecture by the determination unit, the transmission unit transmits, to the information processing apparatus, identification information corresponding to a device driver having the first architecture which can handle a command type handled by the device driver having the second architecture specified by the specification unit or identification information corresponding to a device driver having the first architecture which can handle a command type preset in the peripheral device, and
wherein, in a case where the device driver having the first architecture is specified by the specification unit and where the operating system is determined to support only device drivers having the first architecture by the determination unit, the transmission unit transmits, to the information processing apparatus, identification information corresponding to the device driver having the first architecture specified by the specification unit.

4. The peripheral device according to claim 3, wherein, in a case where the information processing apparatus is connected to the peripheral device via a USB cable, the acquisition unit acquires the information of the operating system operating on the information processing apparatus after identification information corresponding to the device driver specified by the specification unit or dummy identification information is transmitted to the information processing apparatus, and
wherein, in a case where a device driver having the second architecture is specified by the specification unit and where the operating system is determined to support only device drivers having the first architecture by the determination unit, the transmission unit, after a bus reset is issued, transmits, to the information processing apparatus, identification information corresponding to a device driver having the first architecture which can handle a command type handled by the device driver having the second architecture specified by the specification unit or identification information corresponding to a device driver having the first architecture which can handle a command type preset in the peripheral device.

5. The peripheral device according to claim 1, wherein the information processing apparatus performs Plug and Play by using the identification information transmitted by the transmission unit.

6. The peripheral device according to claim 1, wherein the command type preset in the peripheral device is set by a vendor of the peripheral device.

7. The peripheral device according to claim 1, wherein the command type is a PDL.

8. A method in a peripheral device comprising:
specifying a device driver to be installed in an information processing apparatus connected to the peripheral device from a list of device drivers including device drivers having a first architecture and device drivers having a second architecture;
acquiring information of an operating system operating on the connected information processing apparatus;
transmitting, in a case where a device driver having the first architecture is specified from the list of device drivers and where the operating system indicated by the acquired information of the operating system supports only device drivers having the second architecture, to the information processing apparatus, identification information corresponding to a device driver having the second architecture which can handle a command type handled by the device driver having the specified first architecture or identification information corresponding to a device driver having the second architecture which can handle a command type preset in the peripheral device; and
transmitting, in a case where a device driver having the second architecture is specified from the list of device drivers and where the operating system indicated by the acquired information of the operating system supports only device drivers having the second architecture, to the information processing apparatus, identification information corresponding to the specified device driver having the second architecture.

9. A non-transitory computer readable storage medium on which is stored a computer program for making a computer execute a method for a peripheral device, the method comprising:
specifying a device driver to be installed in an information processing apparatus connected to the peripheral device from a list of device drivers including device drivers having a first architecture and device drivers having a second architecture;
acquiring information of an operating system operating on the connected information processing apparatus;
transmitting, in a case where a device driver having the first architecture is specified from the list of device drivers and where the operating system indicated by the acquired information of the operating system supports only device drivers having the second architecture, to the information processing apparatus, identification information corresponding to a device driver having the second architecture which can handle a command type handled by the device driver having the specified first architecture or identification information corresponding to a device driver having the second architecture which can handle a command type preset in the peripheral device; and
transmitting, in a case where a device driver having the second architecture is specified from the list of device drivers and where the operating system indicated by the acquired information of the operating system supports only device drivers having the second architecture, to the information processing apparatus, identification information corresponding to the specified device driver having the second architecture.
